(19) United States
(12) Patent Application Publication
(10) Pub. No.: US 2020/0406432 A1
(43) Pub. Date: Dec. 31, 2020

(54) WRENCH FOR REMOVING AND INSTALLING A WATER TANK

(71) Applicants: Bruce Ardente, Providence, RI (US); Chris Van Haaren, East Greenwich, RI (US)

(72) Inventors: Bruce Ardente, Providence, RI (US); Chris Van Haaren, East Greenwich, RI (US)

(21) Appl. No.: 16/914,348

(22) Filed: Jun. 27, 2020

Related U.S. Application Data
(60) Provisional application No. 62/868,196, filed on Jun. 28, 2019.

(51) Int. Cl. B25B 13/50; B25B 13/08; B25B 23/00; B25B 23/16; B25F 1/00

(52) U.S. Cl. CPC B25B 13/50; B25B 13/08; B25F 1/006; B25B 23/16; B25B 23/005

(57) ABSTRACT

A wrench for removing and installing a water tank in a plumbing and/or heating system as shown and described herein can include, an elongated handle portion having opposed proximal and distal ends, and a crescent shaped head portion operatively associated with the distal end of the elongated handle portion. The head portion can include an opening that is adapted and configured to match the hexagonal dimensions of two different common threaded connectors.

### CROSS-REFERENCE TO RELATED APPLICATIONS

This application claims the benefit of U.S. Provisional Patent Application No. 62/868,196 filed Jun. 28, 2019, the contents of which is incorporated herein in its entirety.

### BACKGROUND OF THE INVENTION

### 1. Field of the Invention

The subject application is directed to hand tools, and more particularly, to a wrench for removing and installing an expansion tank in a plumbing and/or heating system.

### 2. Background of the Related Art

During the installation and removal of water tanks, or expansion tanks, in a plumbing and/or heating system, it is necessary to remove a number of threaded connectors holding the tank in place. The threaded connectors are integral to the tank assembly and often hidden from view, in partial view, and/or with difficult access. This makes installation and removal particularly difficult for the technician.

A typical threaded connector will have a hexagonal shape designed adjacent to the threads to facilitate means of utilizing a wrench during assembly or removal. Currently used in the field are conventional wrenches such as a plumber's wrench, an open ended wrench, or channel locking pliers.

Such conventional methods and systems have generally been considered satisfactory for their intended purpose. However, there is still a need in the art for an improved tank wrench that overcomes the deficiencies associated with conventional wrenches noted above. The present disclosure provides a solution for this need.

### SUMMARY

A wrench for removing and installing a water tank in a plumbing and/or heating system as shown and described herein can include, an elongated handle portion having a longitudinal axis and opposed proximal and distal ends, and a crescent shaped head portion operatively associated with the distal end of the elongated handle portion, wherein the head portion includes an opening that is adapted and configured to match the hexagonal dimensions of two different common threaded connectors. The wrench can be constructed from chrome vanadium steel or a similar metal alloy.

The head portion can include an opening of the crescent shaped head portion configured to accommodate a hexagonal first threaded connector having an outer diameter measured between opposed parallel longitudinal surfaces of about 1.090 inches. The head portion can also include an opening of the crescent shaped head portion to accommodate a second hexagonal threaded connector having an outer diameter measured between opposed parallel longitudinal surfaces of about 0.900 inches. The opening in the head portion can have a peripheral wall that extends beyond the upper and lower surfaces of the head portion, configured to prevent slippage or misengagement. The peripheral wall of the opening of the head portion can have a height of about 0.5 inches.

A shaped spike can extend radially outward from an outer periphery of the head portion for striking the water tank to create hole therein. The shaped spike can extend radially outward from the outer periphery for a length of about 0.375 inches. The shaped spike can have a generally pyramidal shape.

The elongated handle portion can include a resting feature adjacent the head portion configured to rest on a surface of the water tank to provide alignment of the wrench in the torque plane for engagement of the hexagonal threaded connector. The elongated handle portion can be a length of about 15 inches as measured from the proximal end of the handle portion to a distal-most surface of the head portion. The elongated handle portion is integrally formed with the head portion. The elongated handle portion can also have an inner thickness and an outer thickness, wherein the inner thickness is less than the outer thickness, the inner thickness being about 0.25 inches measured perpendicular to the longitudinal axis, the outer thickness being about 0.375 inches measured perpendicular to the longitudinal axis.

The elongated handle portion can also include a proximal end section that is covered by a rubberized hand grip. The hand grip can be constructed from 80 Shore A rubber, or similar material. The hand grip can be configured to extend about 5 inches up the elongated handle portion from the distal end of the elongated handle portion. The hand grip can also be about 1 inch wide and about 1 inch thick. The rubberized hand grip can be integrally formed with the elongated handle portion. The rubberized hand grip and elongated handle portion include a longitudinal void.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art will readily understand how to make and use the hand tool of the subject invention without undue experimentation, embodiments thereof will be described in detail herein below with reference to certain figures, wherein:

FIG. 1 is a perspective view of the tank wrench of the subject invention;

FIG. 2 is a top plan view of the tank wrench of FIG. 1;

FIG. 3 is an enlarged top plan view of the head portion of the tank wrench of FIG. 1;

FIG. 4 is a side plan view of the tank wrench of FIG. 1.

FIG. 5 is a top plan view of another tank wrench constructed in accordance with the present disclosure; and

FIG. 6 is a side plan view of the tank wrench of FIG. 5.

### DETAILED DESCRIPTION

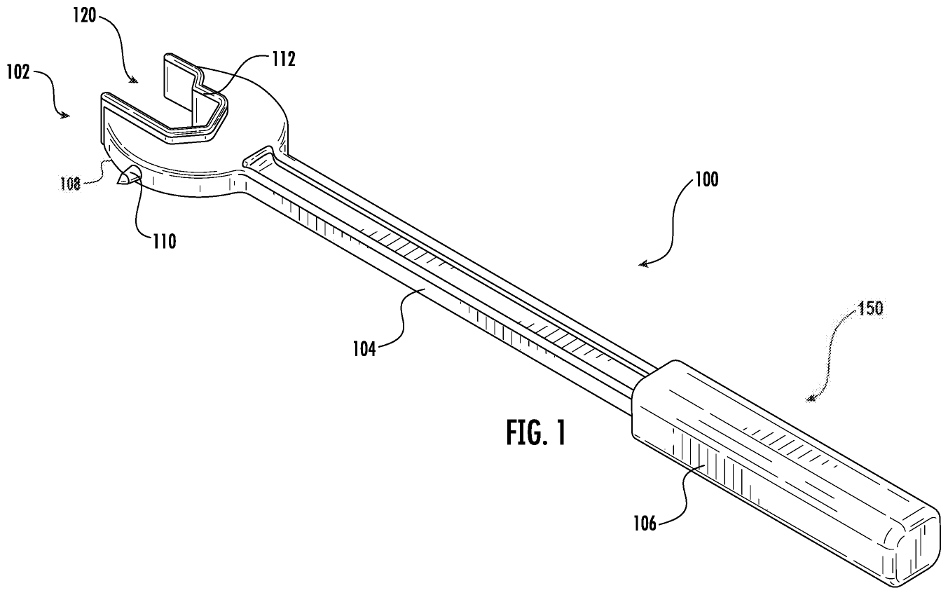

Reference will now be made to the drawings wherein like reference numerals identify similar structural features or aspects of the subject disclosure. For purposes of explanation and illustration, and not limitation, an illustrative view of an embodiment of a tank wrench in accordance with the disclosure is shown in FIG. 1 and is designated generally by reference character 100. Other embodiments and/or aspects of this disclosure are shown in FIGS. 1-6.

With reference to FIG. 1, a wrench 100 for removing and installing a water tank (not shown) in a plumbing and/or heating system as shown and described herein can include, an elongated handle portion 104 having a longitudinal axis A (shown in FIG. 2) and opposed proximal and distal ends, and a crescent shaped head portion 102 operatively associated with the distal end of the elongated handle portion 104. The head portion 102 can include an opening 120 that is adapted and configured to match the hexagonal dimensions of two different common threaded connectors. The wrench 100 can be constructed from chrome vanadium steel or a similar metal alloy.

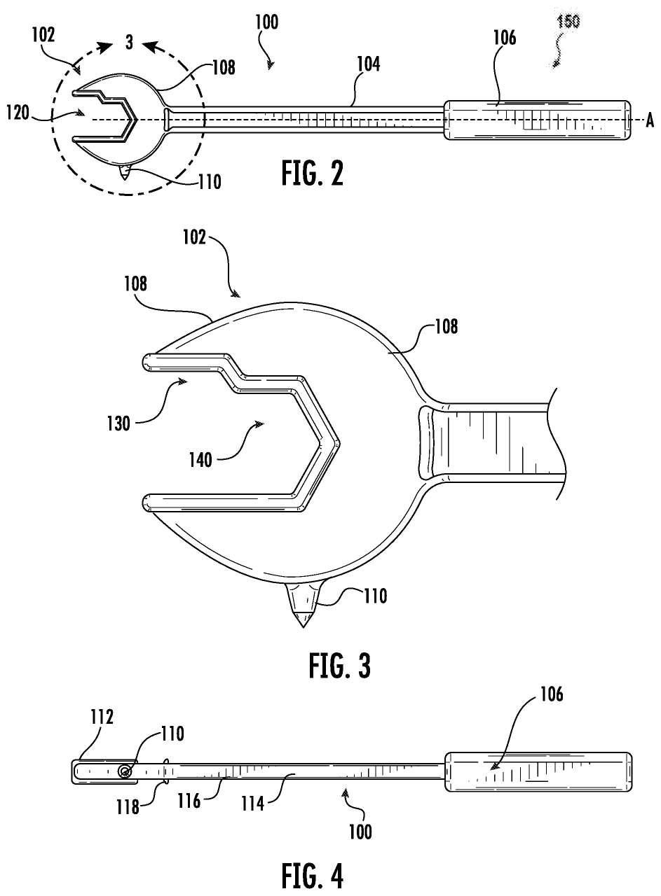

The head portion 102 can include an opening 130 configured to accommodate a first hexagonal threaded connector having an outer diameter of about 1.090 inches (e.g. as shown in FIG. 3), where the outer diameter of the threaded connector is measured between opposed parallel longitudinal surfaces. The head portion 102 can also include an opening 140 that is configured to accommodate a second hexagonal threaded connector having an outer diameter of about 0.900 inches (e.g. as shown in FIG. 3) where the outer diameter of the threaded connector is measured between opposed parallel longitudinal surfaces. The opening 120 of the head portion 102 can have a peripheral wall 112 that extends beyond upper and lower surfaces of the head portion 102 configured to prevent slippage or misengagement. The peripheral wall 112 of the opening 120 can have a height of about 0.5 inches, while the head portion 102 can have a height of about 0.375 inches.

The wrench can further include a shaped spike 110 which can extend radially outward from an outer periphery 108 of the head portion 102 for striking a water tank to create hole therein. The shaped spike 110 can extend radially outward from the outer periphery 108 of the head portion 102 for a length of about 0.375 inches. The shaped spike 110 can have a generally pyramidal shape as shown in FIG. 3, or any other shape suitable for creating a hole in a water tank via strike to facilitate a vent that allows water to drain from the tank through the water connection after removal from the system.

The elongated handle portion 104 can include a resting feature 118 adjacent the head portion 102 configured to rest on a surface of a water tank to prevent misalignment (e.g. as best seen in FIG. 4). The elongated handle 104 portion can be a length of about 15 inches as measured from the proximal end of the handle portion 104 to a distal-most surface of the head portion 102. The elongated handle portion 104 can also be of any length suitable to provide sufficient torque to overcome the break resistance of rust or corrosion. The elongated handle portion can have an inner thickness 114 and an outer thickness 116, wherein the inner thickness 114 is less than the outer thickness 116, the inner thickness 114 being about 0.25 inches and the outer thickness 116 being about 0.375 inches, where the inner and outer thickness are measured perpendicular to the longitudinal axis.

The elongated handle portion 104 can include a proximal end section 150 that is covered by a rubberized hand grip 106. The hand grip can be constructed from 80 Shore A rubber, or similar material suitable for cushioning a hand when applying significant torque or striking a water tank. A rubberized hand grip also serves to prevent impact shock from translating to the piping system due to dynamic load of striking wrench with object such as hammer when removing tank from system. A rubberized grip can transfer torque but will absorb impact shock that may harm other components in the piping system. The hand grip 106 can be configured to extend about 5 inches up the elongated handle portion 104 starting from the distal end of the elongated handle portion 104. The hand grip 106 can also have a cross sectional area of about 1 square inch.

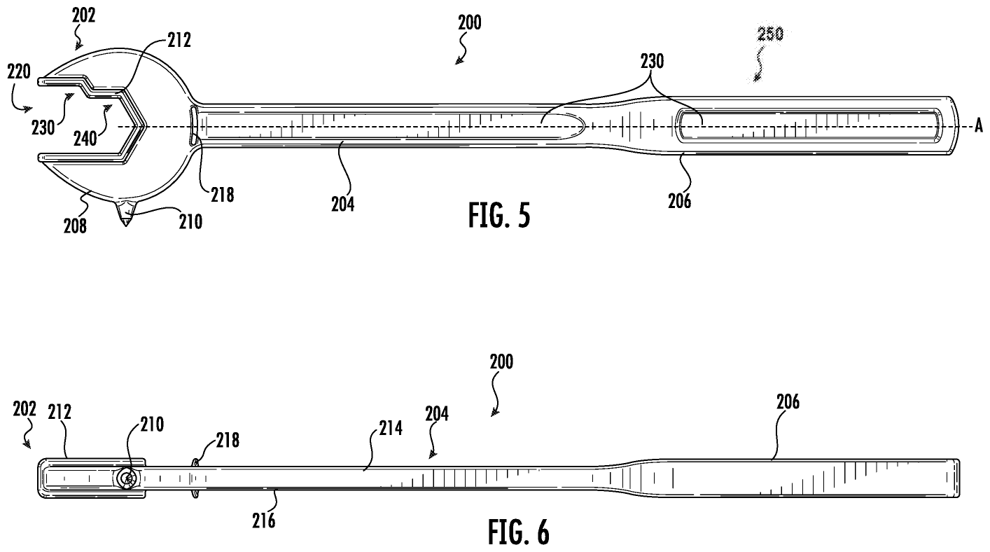

As shown in FIGS. 5-6. A tank wrench 200 can include a head portion 202 and an elongated handle portion 204. The elongated handle portion 204 can also include and a rubberized hand grip 206 disposed at a proximal end section 250 of the elongated handle portion 204. The elongated handle portion can be integrally formed with head portion 202, and the rubberized hand grip 206 can be integrally formed with elongated handle portion 204 to form a continuous wrench body. The wrench 200 can also comprise longitudinal voids 230 disposed within either the elongated handle portion 204 or the hand grip 206 or both.

Like wrench 100, wrench 200 can also include an opening 220 having an opening 230 and 240 each configured to engage with a common threaded connector. The wrench 200 can further include a resting feature 218, a shaped spike 210 extending radially outward from an outer periphery 208 of the head portion, and a peripheral wall 212.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement wrenches for removing and installing water tanks. While the subject disclosure includes reference to certain embodiments, those skilled in the art will readily appreciate that changes and/or modifications may be made thereto without departing from the spirit and scope of the subject disclosure.

What is claimed is:

1. A wrench for removing and installing a water tank in a plumbing and/or heating system, comprising:
an elongated handle portion having a longitudinal axis and opposed proximal and distal ends; and
a crescent shaped head portion operatively associated with the distal end of the elongated handle portion, wherein the head portion includes an opening that is adapted and configured to match the hexagonal dimensions of two different common threaded connectors.

2. A wrench as recited in claim 1, wherein the opening of the head portion is configured to accommodate a first hexagonal threaded connector having an outer diameter as measured between opposed parallel longitudinal surfaces of about 1.090 inches.

3. A wrench as recited in claim 1, wherein the opening of the head portion is configured to accommodate a second hexagonal threaded connector having an outer diameter as measured between opposed parallel longitudinal surfaces of about 0.900 inches.

4. A wrench as recited in claim 1, wherein the opening in the head portion has a peripheral wall that extends beyond the upper and lower surfaces of the head portion, configured to prevent slippage or misengagement.

5. A wrench as recited in claim 4, wherein the peripheral wall of the head portion has a thickness of about 0.5 inches.

6. A wrench as recited in claim 1, wherein a shaped spike extends radially outward from an outer periphery of the head portion for striking the water tank to create hole therein.

7. A wrench as recited in claim 6, wherein the shaped spike extends radially outward about 0.375 inches from the outer periphery of the head portion

8. A wrench as recited in claim 7, wherein the spike is pyramidal shaped.

9. A wrench as recited in claim 1, wherein the elongated handle portion includes a resting feature adjacent the head portion configured to rest on a surface of the water tank to prevent misalignment.

10. A wrench as recited in claim 1, wherein a proximal end section of the elongated handle portion includes a rubberized hand grip.

11. A wrench as recited in claim 10, wherein the rubberized hand grip extends about 5 inches from the distal end of the handle portion towards the head portion.

12. A wrench as recited in claim 10, wherein the rubberized hand grip is integrally formed with the elongated handle portion.

13. A wrench as recited in claim 12, wherein the rubberized hand grip and elongated handle portion include a longitudinal void.

14. A wrench as recited in claim 10, wherein the rubberized hand grip is about 1 inch wide and about 1 inch thick.

15. A wrench as recited in claim 10, wherein the rubberized hand grip is constructed of 80 Shore A rubber.

16. A wrench as recited in claim 1, wherein the overall length of the wrench is about 15 inches as measured from the proximal end of the handle portion to a distal-most surface of the head portion.

17. A wrench as recited in claim 1, wherein the elongated handle portion is integrally formed with the head portion.

18. A wrench as recited in claim 1, wherein the elongated handle portion has an inner thickness and an outer thickness, wherein the inner thickness is about 0.25 inches measured perpendicular to the longitudinal axis and the outer thickness is about 0.375 inches measured perpendicular to the longitudinal axis.

19. A wrench as recited in claim 1, wherein the wrench is constructed from chrome vanadium steel.
